(19) United States
(12) Patent Application Publication
(10) Pub. No.: US 2025/0337532 A1
(43) Pub. Date: Oct. 30, 2025

(54) METHOD AND USER EQUIPMENT FOR DETERMINING UPLINK RE-TRANSMISSION STRATEGY

(71) Applicant: MEDIATEK INC., Hsinchu City (TW)

(72) Inventors: Chih-Chieh LAI, Hsinchu City (TW); Jianwei ZHANG, Beijing (CN); Yabo LI, San Jose, CA (US); Huan XU, San Jose, CA (US); Srikanth ISANAKA, Bengaluru KA (IN); Shih-Ping LIANG, Hsinchu City (TW); Hao-En HUANG, Hsinchu City (TW)

(21) Appl. No.: 18/651,300

(22) Filed: Apr. 30, 2024

(51) Int. Cl. H04L 1/1812; H04L 1/1829

(52) U.S. Cl. CPC H04L 1/1816; H04L 1/1829

(57) ABSTRACT

A method for determining an uplink re-transmission strategy is provided. The method is applied to user equipment (UE). The method includes the following steps. A data re-transmission configuration from a network applicable to a Hybrid Automatic Repeat Request (HARQ) process is received. Target data are transmitted to the network. A message from the network associated with the target data is received. The probability, which is higher than a certain threshold, that the network is able to decode the target data based on a data re-transmission on a physical uplink shared channel (PUSCH) is determined. The data re-transmission is transmitted to the network through the PUSCH if the determination is positive.

### FIELD OF THE INVENTION

The present invention relates to a communication system, and, in particular, to a method and user equipment for determining an uplink re-transmission strategy.

### DESCRIPTION OF THE RELATED ART

There are instances when user equipment (UE) may fail to successfully transmit new data for an Uplink Hybrid Automatic Repeat Request (UL HARQ) process due to factors such as power shortage. In response, a network (NW) schedules the UE for subsequent re-transmissions.

However, the network might not successfully decode the Physical Uplink Shared Channel (PUSCH) with re-transmissions alone, resulting in inefficiency as the UE expends significant power on these re-transmissions.

### BRIEF SUMMARY OF THE INVENTION

An embodiment of the present invention provides a method for determining an uplink re-transmission strategy. The method is applied to user equipment (UE). The method includes the following steps. A data re-transmission configuration from a network applicable to a Hybrid Automatic Repeat Request (HARQ) process is received. Target data are transmitted to the network. A message from the network associated with the target data is received. It is determined that the probability that the network is able to decode the target data based on a data re-transmission on a physical uplink shared channel (PUSCH) is higher than a certain threshold. The data re-transmission is transmitted to the network through the PUSCH if the determination is positive.

According to the method described above, the step of receiving the data re-transmission configuration from the network applicable to the HARQ process includes the following step. The data re-transmission configuration from the network is received through a physical downlink control channel (PDCCH)

According to the method described above, the message from the network associated with the target data is a NACK or a PHY message.

According to the method described above, the step of determining the probability is associated with the certain threshold of the original code book's systematic bits.

According to the method described above, the step of determining the probability, which is higher than the certain threshold, that the network is able to decode the target data based on the data re-transmission includes the following step. A redundancy version (RV) for generating the data re-transmission is determined.

According to the method described above, the step of determining the probability, which is higher than a certain threshold, that the network is able to decode the target data based on the data re-transmission includes the following step. It is determined that a code rate of the data re-transmission scheduled by the network is lower than a threshold value.

According to the method described above, the step of determining the probability, which is higher than a certain threshold, that the network is able to decode the target data based on the data re-transmission includes the following step. It is determined that systematic bits of a code block in the data re-transmission occupy more than a threshold percentage.

According to the method described above, the step of determining the probability, which is higher than a certain threshold, that the network is able to decode the target data based on the data re-transmission includes the following step. It is determined that a signal-to-interference-and-noise ratio (SINR) estimated by the UE for an uplink transmission is higher than a threshold value.

The method further includes the following steps. The data re-transmission to the network through the PUSCH is ignored if the determination is negative.

An embodiment of the present invention also provides user equipment (UE). The UE includes an antenna, a transceiver, and a processor. The transceiver is electrically connected to the antenna. The processor is electrically connected to the transceiver. The processor receives a data re-transmission configuration from a network applicable to a Hybrid Automatic Repeat Request (HARQ) process through the antenna and the transceiver. The processor transmits target data to the network through the antenna and the transceiver. The processor receives a message from the network associated with the target data through the antenna and the transceiver. The processor determines the probability, which is higher than a certain threshold, that the network is able to decode the target data based on a data re-transmission on a physical uplink shared channel (PUSCH). The processor transmits the data re-transmission to the network through the PUSCH if the determination is positive.

According to the UE described above, the processor receives the data re-transmission configuration from the network through a physical downlink control channel (PDCCH).

According to the UE described above, the message from the network associated with the target data is a NACK or a PHY message.

According to the UE described above, the processor determines the probability based on the certain threshold of original code book's systematic bits.

According to the UE described above, when the processor determines that a redundancy version (RV) for generating the data re-transmission, the processor determines that the network is able to decode the target data based on the data re-transmission.

According to the UE described above, when the processor determines that a code rate of the data re-transmission scheduled by the network is lower than a threshold value, the processor determines that the network is able to decode the target data based on the data re-transmission.

According to the UE described above, when the processor determines that systematic bits of a code block in the data re-transmission occupy more than a threshold percentage, the processor determines that the network is able to decode the target data based on the data re-transmission.

According to the UE described above, when the processor determines that a signal-to-interference-and-noise ratio (SINR) estimated by the UE for an uplink transmission is higher than a threshold value, the processor determines that the network is able to decode the target data based on the data re-transmission.

According to the UE described above, when the processor ignores the data re-transmission to the network through the PUSCH if the determination is negative.

### BRIEF DESCRIPTION OF THE DRAWINGS

The present invention can be more fully understood by reading the subsequent detailed description and examples with references made to the accompanying drawings, wherein:

FIG. 1 is a flow chart of a method for determining an uplink re-transmission strategy in accordance with some embodiments of the present invention.

FIG. 2 is a schematic diagram of a communication system 100 in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” and/or “include” used in the present invention are used to indicate the existence of specific technical features, values, method steps, operations, units and/or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, and/or materials used in specific embodiments. However, the drawings should not be construed as defining or limiting the scope or properties encompassed by these embodiments. For example, for clarity, the relative size, thickness, and position of each layer, each area, and/or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, “third”, “fourth”, “fifth”, and “sixth” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

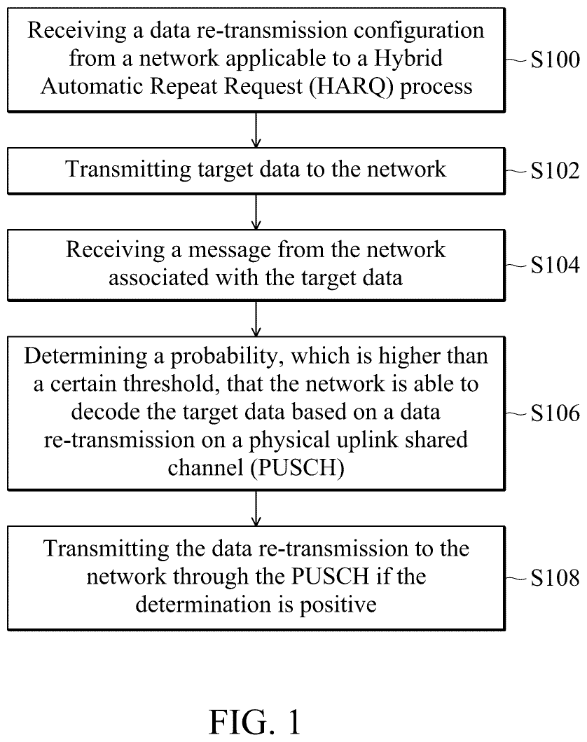

FIG. 1 is a flow chart of a method for determining an uplink re-transmission strategy in accordance with some embodiments of the present invention. As shown in FIG. 1, the method for determining the uplink re-transmission strategy of the present invention includes the following steps. A data re-transmission configuration from a network applicable to a Hybrid Automatic Repeat Request (HARQ) process is received (step S100). Target data are transmitted to the network (step S102). A message from the network associated with the target data is received (step S104). The probability, which is higher than a certain threshold, that the network is able to decode the target data based on a data re-transmission on a physical uplink shared channel (PUSCH) is determined (step S106). The data re-transmission is transmitted to the network through the PUSCH if the determination is positive (step S108).

In some embodiments, steps S100˜S108 are performed by user equipment (UE). In some embodiments, the UE may be a laptop, a tablet, or a smart phone, but the present invention is not limited thereto. In some embodiments, the UE is included in a communication system, which further includes a base station. The UE is able to access a network through the base station. The UE is connected with the base station by Radio Resource Control (RRC) signaling, but the present invention is not limited thereto. In some embodiments, the base station may be a gNB, but the present invention is not limited thereto.

In step S100, the UE is configured by the network to transmit the data re-transmission. In some embodiments, the UE receives the data re-transmission configuration from the network through a physical downlink control channel (PDCCH). Next, in step S102, the UE transmits target data to the network. In some embodiments, the UE fails to transmit the target data for an uplink hybrid automatic repeat request (UL HARQ) process due to a power shortage in the UE. For example, when the Relative State-Of-Charge (RSOC) of the battery in the UE is lower than a threshold value, the UE may fail to transmit the target data for the UL HARQ process. The threshold value may be 5% of the RSOC of the battery, but the present invention is not limited thereto.

In step S104, the UE receives a message from the network associated with the target data. In some embodiments, the UE receives the message from the network through the PDCCH to transmit the re-transmission. In some embodiments, when a timeout expires and the network still does not receive the target data from the UE, the network may configure the UE to transmit the data re-transmission. In some embodiments, the message from the network associated with the target data is a NACK or a PHY message, but the present invention is not limited thereto.

Next, in step S106, the UE determines the probability, which is higher than a certain threshold, that the network is able to decode the target data based on the data re-transmission on a physical uplink shared channel (PUSCH). In some embodiments, the aforementioned certain threshold may be 70% of the probability, but the present invention is not limited thereto. In some embodiments, the UE determines the probability that the network is able to decode the target data based on the data re-transmission on the PUSCH based on a redundancy version (RV) for generating the data re-transmission, a code rate of the data re-transmission scheduled by the network, systematic bits of a code block in the data re-transmission, and/or a signal-to-interference-and-noise ratio (SINR) estimated by the UE for an uplink transmission. In some embodiments, the step of determining the probability in step S106 is associated with the certain threshold of original code book's systematic bits.

In some embodiments, when the UE determines the RV for generating the data re-transmission, the UE may perform the subsequent step S108. For example, when the UE determines the RV for generating the data re-transmission is consequent, the UE may perform the subsequent step S108. In some embodiments, when the UE determines that the code rate of the data re-transmission scheduled by the network is lower than a threshold value, the UE may perform the subsequent step S108. In general, the lower the code rate is, the higher the probability for the network to successfully decode the PUSCH.

In some embodiments, when the UE determines that systematic bits of a code block in the data re-transmission occupy more than a threshold percentage, the UE may perform the subsequent step S108. In general, the higher the percentage the systematic bits of the code block is occupied, the higher the probability for the network to successfully decode the PUSCH. In some embodiments, when the UE determines that a signal-to-interference-and-noise ratio (SINR) estimated by the UE for an uplink transmission is higher than a threshold value, the UE may perform the subsequent step S108. In general, the higher the SINR is, the higher the probability for the network to successfully decode the PUSCH. After that, in step S108, the UE transmits the data re-transmission to the network through the PUSCH if the determination is positive.

In contrast, when the UE determines the probability that the network is able to decode the target data based on the data re-transmission is lower than or equal to a certain threshold, that is, the determination in step S106 is negative, the UE ignores the data re-transmission to the network through the PUSCH. In some embodiments, when the UE determines that the RV for generating the data re-transmission is not appropriate, the UE may not perform the subsequent step S108. In some embodiments, when the UE determines that the code rate of the data re-transmission scheduled by the network is higher than or equal to a threshold value, the UE may not perform the subsequent step S108.

In some embodiments, when the UE determines that systematic bits of a code block in the data re-transmission are occupied less than or equal to a threshold percentage, the UE may not perform the subsequent step S108. In some embodiments, when the UE determines that an SINR estimated by the UE for an uplink transmission is lower than or equal to a threshold value, the UE may not perform the subsequent step S108.

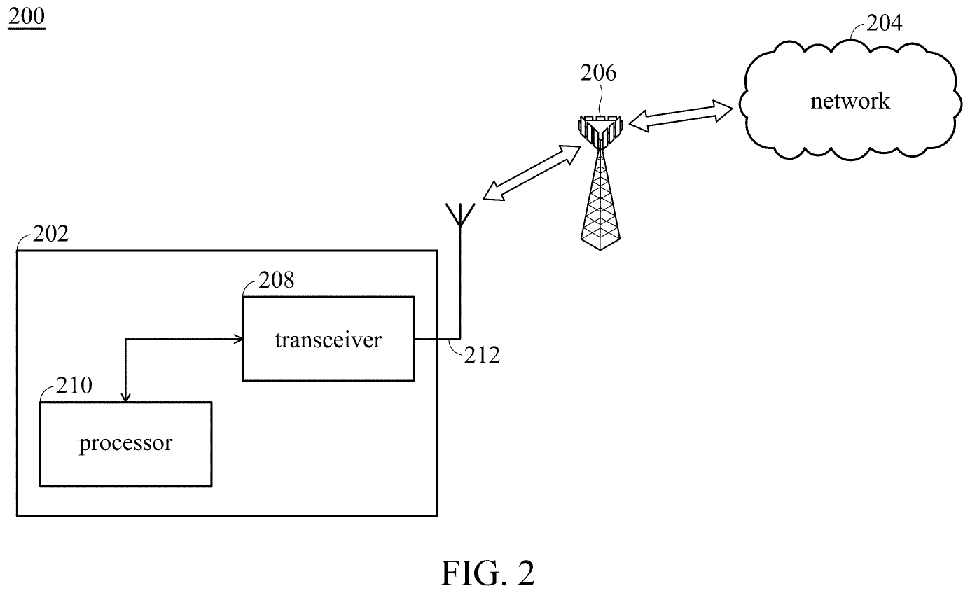

FIG. 2 is a schematic diagram of a communication system 100 in accordance with some embodiments of the present invention. As shown in FIG. 2, the communication system 200 includes a UE 202, a network 204, and a base station 206. In some embodiments, the UE 202 may be a laptop, a tablet, or a smart phone, but the present invention is not limited thereto. In some embodiments, the UE 202 is able to access the network 204 through the base station 206. The UE 202 is connected with the base station 206 by Radio Resource Control (RRC) signaling, but the present invention is not limited thereto. In some embodiments, the base station 206 may be a gNB, but the present invention is not limited thereto.

In some embodiments, the UE 202 includes an antenna 212, a transceiver 208, and a processor 210. The transceiver 208 is electrically connected between the antenna 212 and the processor 210. The processor 210 may be an application processor, but the present invention is not limited thereto. In some embodiments, the UE 202 further includes a memory (not shown) storing a plurality of codes. The processor 210 reads the codes stored in the memory to execute the steps as follows. The processor 210 receives a data re-transmission configuration from the network 204 applicable to a Hybrid Automatic Repeat Request (HARQ) through the antenna 112 and the transceiver 208. Next, the processor 210 transmits target data through the antenna 112 and the transceiver 208.

After that, the processor 210 receives a message from the network 204 associated with the target data through the antenna 212 and the transceiver 208. In some embodiments, the message from the network 204 associated with the target data is a NACK or a PHY message. The processor 210 determines the probability, which is higher than a certain threshold, that the network 204 is able to decode the target data based on a data re-transmission on a physical uplink shared channel (PUSCH). Then, the processor 210 transmits the data re-transmission to the network 204 through the PUSCH if the determination is positive.

In some embodiments, the processor 210 receives the data re-transmission configuration from the network 204 through a physical downlink control channel (PDCCH). In some embodiments, the processor 210 fails to transmit the target data for an uplink hybrid automatic repeat request (UL HARQ) process due to a power shortage in the UE 202. For example, when the RSOC of the battery in the UE 202 is lower than a threshold value, the processor 210 may fail to transmit the target data for the UL HARQ process. In some embodiments, the processor 210 receives the message from the network 204 associated with the target data through the PDCCH. In some embodiments, the processor 210 determines the probability based on the certain threshold of original code book's systematic bits.

In some embodiments, when the processor 210 determines a redundancy version (RV) for generating the data re-transmission, the processor 210 determines that the network 204 is able to decode the target data based on the data re-transmission on the PUSCH. For example, when the processor 210 determines that the RV of the re-transmission scheduled by the network 204 is consequent, the processor 210 may determine that the network 204 is able to decode the target data based on the data re-transmission on the PUSCH. After that, the processor 210 may transmit the data re-transmission to the network 204 through PUSCH.

In some embodiments, when the processor 210 determines that a code rate of the data re-transmission scheduled by the network 204 is lower than a threshold value, the processor 210 determines that the network 204 is able to decode the target data based on the data re-transmission on the PUSCH. In general, the lower the code rate is, the higher the probability for the network 204 to successfully decode the PUSCH. After that, the processor 210 may transmit the data re-transmission to the network 204 through PUSCH.

In some embodiments, when the processor 210 determines that systematic bits of a code block in the re-transmission occupy more than a threshold percentage, the processor 210 determines that the network 204 is able to decode the target data based on the data re-transmission on the PUSCH. In general, the higher the percentage the systematic bits of the code block is occupied, the higher the probability for the network 204 to successfully decode the PUSCH. After that, the processor 210 may transmit the data re-transmission to the network 204 through the PUSCH.

In some embodiments, when the processor 210 determines that a signal-to-interference-and-noise ratio (SINR) estimated by the UE 202 for an uplink transmission is higher than a threshold value, the processor 210 determines that the network 204 is able to decode the target data based on the data re-transmission on the PUSCH. After that, the processor 210 may transmit the data re-transmission to the network 204 through the PUSCH. In general, the higher the SINR is, the higher the probability for the network 204 to successfully decode the PUSCH.

In contrast, when the processor 210 determines the probability that the network 204 is able to decode the target data based on the data re-transmission on the PUSCH is lower than or equal to the certain threshold, the processor 210 does not transmit the data re-transmission to the network 204. In some embodiments, the processor 210 ignores the data re-transmission to the network 204 through the PUSCH if the determination is negative.

The method and the UE 202 equipped with the present invention can conserve power for those insufficient transmissions. More importantly, the UE 202 can lower down the risk of triggering the same shortage that led to its initial failure to transmit the new-transmission.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for determining an uplink re-transmission strategy, applied to user equipment (UE), comprising:
receiving a data re-transmission configuration from a network applicable to a Hybrid Automatic Repeat Request (HARQ) process;
transmitting target data to the network;
receiving a message from the network associated with the target data;
determining a probability, which is higher than a certain threshold, that the network is able to decode the target data based on a data re-transmission on a physical uplink shared channel (PUSCH); and
transmitting the data re-transmission to the network through the PUSCH if the determination is positive.

2. The method as claimed in claim 1, wherein the step of receiving the data re-transmission configuration from the network applicable to a Hybrid Automatic Repeat Request (HARQ) process comprises:
receiving the data re-transmission configuration from the network through a physical downlink control channel (PDCCH).

3. The method as claimed in claim 1, wherein the message from the network associated with the target data is a NACK or a PHY message

4. The method as claimed in claim 1, wherein the step of determining the probability is associated with the certain threshold of original code book's systematic bits.

5. The method as claimed in claim 1, wherein the step of determining the probability, which is higher than the certain threshold, that the network is able to decode the target data based on the data re-transmission comprises:
determining a redundancy version (RV) for generating the data re-transmission.

6. The method as claimed in claim 1, wherein the step of determining the probability, which is higher than the certain threshold, that the network is able to decode the target data based on the data re-transmission comprises:
determining that a code rate of the data re-transmission scheduled by the network is lower than a threshold value.

7. The method as claimed in claim 1, wherein the step of determining the probability, which is higher than the certain threshold, that the network is able to decode the target data based on the data re-transmission comprises:
determining that systematic bits of a code block in the data re-transmission occupy more than a threshold percentage.

8. The method as claimed in claim 1, wherein the step of determining the probability, which is higher than the certain threshold, that the network is able to decode the target data based on the data re-transmission comprises:
determining that a signal-to-interference-and-noise ratio (SINR) estimated by the UE for an uplink transmission is higher than a threshold value.

9. The method as claimed in claim 1, further comprising:
ignoring the data re-transmission to the network through the PUSCH if the determination is negative.

10. A user equipment (UE), comprising:
an antenna;
a transceiver, electrically connected to the antenna; and
a processor, electrically connected to the transceiver, configured to:
receive a data re-transmission configuration from a network applicable to a Hybrid Automatic Repeat Request (HARQ) process through the antenna and the transceiver;
transmit target data to the network through the antenna and the transceiver;
receive a message from the network associated with the target data through the antenna and the transceiver;
determine a probability, which is higher than a certain threshold, that the network is able to decode the target data based on a data re-transmission on a physical uplink shared channel (PUSCH); and
transmit the data re-transmission to the network through the PUSCH if the determination is positive.

11. The UE as claimed in claim 10, wherein the processor receives the data re-transmission configuration from the network through a physical downlink control channel (PDCCH).

12. The UE as claimed in claim 10, wherein the message from the network associated with the target data is a NACK or a PHY message.

13. The UE as claimed in claim 10, wherein the processor determines the probability based on the certain threshold of original code book's systematic bits.

14. The UE as claimed in claim 10, wherein when the processor determines a redundancy version (RV) for generating the data re-transmission, the processor determines that the network is able to decode the target data based on the data re-transmission.

15. The UE as claimed in claim 10, wherein when the processor determines that a code rate of the data re-transmission scheduled by the network is lower than a threshold value, the processor determines that the network is able to decode the target data based on the data re-transmission.

16. The UE as claimed in claim 10, wherein when the processor determines that systematic bits of a code block in the data re-transmission occupy more than a threshold percentage, the processor determines that the network is able to decode the target data based on the data re-transmission.

17. The UE as claimed in claim 10, wherein when the processor determines that a signal-to-interference-and-noise ratio (SINR) estimated by the UE for an uplink transmission is higher than a threshold value, the processor determines that the network is able to decode the target data based on the data re-transmission.

18. The UE as claimed in claim 10, wherein the processor ignores the data re-transmission to the network through the PUSCH if the determination is negative.
